(19) United States
(12) Patent Application Publication
(10) Pub. No.: US 2024/0352379 A1
(43) Pub. Date: Oct. 24, 2024

(54) BORATE-FREE, AQUEOUS COMPOSITION FOR CLEANING AND TREATING METALLIC SUBSTRATES

(71) Applicant: Chemetall GMBH, Frankfurt (DE)

(72) Inventors: Berit ROESNER, Frankfurt (DE); Carola KOMP, Frankfurt (DE)

(21) Appl. No.: 18/686,100

(22) PCT Filed: Sep. 26, 2022
(86) PCT No.: PCT/EP22/76659

§ 371 Date: Feb. 23, 2024

(30) Foreign Application Priority Data
Sep. 27, 2021 (EP) 21199169.0

(51) Int. Cl. C11D 3/10; C11D 3/00; C11D 3/06; C11D 3/08; C11D 17/00; C23G 1/14

(52) U.S. Cl. CPC C11D 3/10; C11D 3/0047; C11D 3/06; C11D 3/08; C11D 17/0008; C23G 1/14; C11D 2111/16

(57) ABSTRACT

Disclosed herein is a borate-free, aqueous cleaning and treating composition including at least one metasilicate (A); at least one orthophosphate (B); at least one phosphate (C); at least one surfactant (D); and where the aqueous cleaning and treating composition has a pH value at 20° C. in a range from 11.0 to 12.8; and possesses a molar ratio of Si atoms to P atoms being from 0.75:1 to 1:0.75, based on the sum of the Si-containing metasilicates (A) and the sum of the P-containing orthophosphates (B), diphosphates (C) and triphosphates (C). Further disclosed herein are solid mixtures. Additionally disclosed herein are a method for cleaning and treating metallic substrates by using the compositions and a method of using the compositions to clean metallic substrates and treat metallic substrates by forming a Si-containing layer on the surface of the metallic substrates.

### FIELD OF THE INVENTION

The present invention relates to borate-free, aqueous compositions for cleaning and treating metallic substrates, preferably aluminum based metallic substrates such as aluminum and its alloys. The invention further relates to the preparation of such compositions and solid mixtures to prepare such compositions as well as a method of cleaning and treating metallic substrates making use of the borate-free, aqueous compositions. Further object of the invention is the use of the compositions of the invention to clean and treat metallic substrates.

### TECHNOLOGICAL BACKGROUND

In constructing various structures from metals, it is important to have the capability of bonding to metallic substrates. This includes bonding metallic substrates to other metallic material, as well as bonding non-metal materials to metallic substrates.

In many applications, it is possible to use simple mechanical bonding mechanisms, such as bolts, screws, or rivets. In other applications, concerns over the added weight of mechanical fasteners make the use of adhesive more viable. Various adhesives are known and commonly used in the art of bonding metals together or bonding non-metal materials to metals. For example, various epoxy-based adhesives are widely used for these applications.

When metals are bonded using an adhesive it is generally important to provide the strongest possible bond. In general, it is difficult to assure a strong bond when using adhesive. For example, processing conditions during bond fabrication often cause dramatic reductions in bond strength. This is particularly true when bonding to metals such as aluminum or its alloys. Bonding to aluminum and aluminum alloys has presented a special challenge.

Aluminum and aluminum alloys are considered difficult metals to bond to because of the propensity of aluminum surfaces to form a weak hydrated surface layer of aluminum oxide. The surface morphology and hence, adhesive bond durability, is dependent upon the type of surface cleaning and treatment received prior to bonding.

The oxide generally found on aluminum is the aluminum oxide (Al₂O₃). This oxide is stable for bonding. However, with time and humidity, this oxide can become hydrated to form a less stable and mechanically weak layer of AlOOH (boehmite) and aluminum trihydroxide (bayerite). The thickness of this layer typically ranges from about 10 nm to about 150 nm, depending on the environment. If an adhesive is applied over this film, a weak boundary layer is incorporated into the bond system. The presence of this weak boundary layer results in decreased bond strength, low fracture toughness, and poor bond durability over time. Similarly, it is often a problem to provide bonds which are of sufficient initial strength.

A widely-used treatment for aluminum surfaces involves vapor degreasing and grit blasting. However, these methods do not prevent further growth of boehmite and bayerite layers on the aluminum surface.

Available cleaning solvents and solutions used in this process have become more restrictive because of environmental regulation on chemical waste disposal. Thus, the combination of process sensitivity, marginal bond durability, and environmental constraints, raises concerns over continued use of traditional surface treatment processes.

There are limited alternative methods of aluminum surface cleaning treatment and preparation. Some of these other methods of aluminum surface preparation involve formation of stable, moisture-resistant oxide layers. These methods include sulfuric, chromic, and phosphoric acid anodization. These electrolytic processes inhibit the further growth of hydroxide layers and enhance initial bond strength and bond durability. In addition, the phosphoric acid process produces a honeycomb surface which is believed to enhance bond strength through mechanical interlocking.

These processes, however, generally consist of a complex series of treatments including degreasing, alkaline cleaning, acid etching, acid anodization, and in some instances, a post treatment process.

Accordingly, what is needed in the art are effective and efficient methods of surface cleaning and treatment of aluminum, and other metals to provide stable adhesive bonding to metal substrates. In that regard, it would be a significant advancement in the art to provide methods of surface treatment and cleaning which are relatively simple, and which use readily available materials.

It would be a further advancement in the art to provide a method of surface cleaning and treatment which provides increased bond strength to adhesive layers.

A further aim of the present invention is to provide a solid mixture consisting of cleaning and treating agents, which just needs to be dissolved in water at the application site to form a cleaning and treating composition for metallic substrates. The solid mixture may just need to be supplemented with an acid or base to adjust the pH value to obtain the optimum value for cleaning and treatment, particularly the cleaning and treatment of aluminum-based substrates. Providing a solid mixture instead of a liquid concentrate has a big advantage when shipping the mixture, because it is volume-optimized, since it is not diluted in water and can thus be shipped without the water content. Water needed to produce a cleaning and or treatment bath can be supplemented at any application site. Thus, providing such solid mixture or dry concentrate adds to the environmentally friendly aspects of the present invention. Of course, such compositions should have a reduced tendency to form agglomerates.

Furthermore, yet another aim of the present invention is to provide borate-free, aqueous cleaning and treating compositions, since borates are to be avoided due to recent plans of the REACH regulation of the European Union. REACH addresses the production and use of chemical substances, and their potential impacts on both human health and the environment.

Moreover, beside the possibility to clean metallic substrates, particularly aluminum- based substrates—but not restricted to those—the composition should be apt to form a silicon-containing surface layer, such as a silicate layer, allowing for a better adhesion of subsequent adhesive layers or coating layers. The formation of such silicon-containing layer should be such that a silicon content at the surface of the metallic substrate, expressed as Si and determined by XRF spectroscopy, should be uniform and preferably in the baseline corrected range of about 2 to 7 mg/m² particularly on the commonly used aluminum alloy AA6014. Such Si-based layers strongly enhance the adhesion of thus treated metallic substrate surfaces to adhesives.

Furthermore, the cleaning and treating compositions should not show excessive pickling.

DE 196 42 723 A1 concerns a process for bonding paint or adhesive with part of the surface of a workpiece made of aluminum or an aluminum alloy, especially aluminum-magnesium alloy, in which said part of the metal surface is pre-silicated with polymerized silicic acid with a degree of polymerization of at least 1 to produce an adhesion-improving layer. The silica was produced by pyrolytic decomposition of a mixture of tetraethoxysilane, tetramethoxysilane and dimethylethoxysilane in a concentration ratio of 1:2:1, a partial pressure of 5 mbar and a pyrolysis time of 0.2 sec in a detonating gas flame (H₂:O₂=2:1). Prior to the treatment with the polymerized silica the substrates were degreased with isopropanol.

WO 2019/042951 A1 discloses a method for the substantially nickel-free phosphating of a metal surface, in which a metal surface is treated with the following compositions one after the other: i) with an alkaline, aqueous cleaning agent composition, which contains at least a water-soluble silicate, and ii) with an acidic, aqueous, substantially nickel-free phosphating composition, which comprises zinc ions, manganese ions and phosphate ions. Besides other substrates aluminum alloys were treated. The alkaline, aqueous cleaning composition used in the method according to WO 2019/042951 A1 is based on waterglass-based compositions mixed with pyrophosphates or polyphosphates and/or boric acid.

U.S. Pat. No. 5,520,768 discloses a two-step surface preparation process particularly for aluminum and aluminum alloy substrates, the process improving bond strength, fracture toughness, durability and failure mode of adhesive bonds by first treating the metallic surfaces with an alkali metal metasilicate solution followed by the treatment with an organofunctional silane. The primary object of the first step was to provide a very thin silicate layer on the surface of the metallic substrate. The compositions used in the process may contain cleaning additives, such as detergents, emulsifiers and terpenes, like D-limonene.

Particularly in view of the before-mentioned U.S. Pat. No. 5,520,768 the present invention was to provide a method for cleaning and treating a metallic surface, which, other than described in U.S. Pat. No. 5,520,768, makes a silane treatment step unnecessary. Cleaning and providing an excellent adhesion for further layers of adhesives and/or coating materials should not depend on whether a second treatment step with e.g., silanes is performed. Beside of the use of surfactants, such as anionic or non-ionic surfactants, no organic compounds should be required in the cleaning and treating compositions of the present invention.

### SUMMARY

The specific aims described above and the aim of overcoming the drawbacks of the prior art were achieved by providing a borate-free, aqueous cleaning and treating composition comprising at least one metasilicate (A); at least one orthophosphate (B); at least one phosphate (C) selected from the group consisting of diphosphates and triphosphates; and at least one surfactant (D) selected from the group consisting of anionic surfactants and non-ionic surfactants; and wherein the aqueous cleaning and treating composition has a pH value at 20° C. in the range from 11.0 to 12.8; and possesses a molar ratio of Si atoms to P atoms from 0.75:1 to 1:0.75, based on the sum of the Si-containing metasilicates (A) and the sum of the P-containing orthophosphates (B), diphosphates (C) and triphosphates (C).

In the following it is also referred to this composition as composition according to the present invention.

A further object of the present invention is a method of preparing the above composition according to the invention, wherein, in a first step (I), a solid mixture (M), comprising at least one metasilicate (A); at least one orthophosphate (B); and at least one phosphate (C) selected from the group consisting of diphosphates and triphosphates; and at least one surfactant (D), selected from the group consisting of anionic surfactants and non-ionic surfactants, is dissolved in water to obtain an aqueous solution; and, in a second step (II), if necessary, the pH value of the aqueous solution obtained in the first step (I) is adjusted to the range indicated for the composition according to the invention, preferably by addition of phosphoric acid or its aqueous solution or by addition of an aqueous solution of an alkaline metal hydroxide.

In the following it is also referred to this method as method of preparing the composition according the present invention.

Yet another object of the present invention is a solid mixture (M) for use in the method of preparing the composition according the present invention, wherein the solid mixture (M) comprises at least one metasilicate (A); preferably at least one orthophosphate (B); at least one phosphate (C) selected from the group consisting of diphosphates and triphosphates; and at least one surfactant (D) selected from the group consisting of anionic surfactants and non-ionic surfactants; wherein at least each species (A), (B) and (C) is solid at 20° C.

In the following it is also referred to this mixture as mixture according to the present invention. The term “solid” refers to the matter of state of the respective ingredients at room temperature (23° C.). While the surfactant (D) may be liquid at room temperature, the other ingredients of the solid mixture (M), namely the at least one metasilicate (A); the preferably at least one orthophosphate (B) and the at least one phosphate (C) selected from the group consisting of diphosphates and triphosphates are typically solid within the above meaning, thus forming together with the surfactant (D) the solid mixture (M). In case a liquid surfactant (D) is used it is preferably applied to the surface of one or more of the solid ingredients.

A further object of the invention is a method of cleaning and treating a metallic substrate, comprising the steps of contacting a metallic substrate with a borate-free, aqueous cleaning and treating composition according to the invention or prepared according to the method of preparing such composition as defined above to obtain a cleaned, surface-treated metallic substrate; and contacting the thus cleaned, surface-treated metallic substrate with an aqueous rinsing composition to remove excessive cleaning and treating composition.

Yet another object of the present invention is the use of the compositions according to the invention to clean and treat metallic substrates, being referred to as the use according to the present invention.

### DETAILLED DESCRIPTION

In the following the objects of the present invention are described in more detail. Particularly the preferred ingredients contained in the compositions and mixtures according to the invention, as well as the preferred method steps and process conditions are described.

### Borate-Free, Aqueous Cleaning and Treating Composition

The borate-free, aqueous cleaning and treating composition according to the present invention contains at least one metasilicate (A); at least one orthophosphate (B); and at least one phosphate (C) selected from the group consisting of diphosphates and triphosphates. (A), (B) and (C) as employed in the cleaning and treating composition according to the present invention preferably possess a water-solubility at 20° C. of at least 50 g/L, thus are completely dissolvable at 20° C. in the composition according to the invention.

Surfactants (D), are also dissolved, for example in form of micelles, in the borate-free, aqueous cleaning and treating composition according to the invention.

It was found by the inventors that the optimum performance regarding the cleaning and treating effect of the composition is achieved, if the compositions pH value at 20° C. is in the range from 11.0 to 12.8, preferably 11.3 to 12.5 and most preferred 11.6 to 12.2. In case the pH value is lower than 11.0 at 20° C., the pH value of such composition at 80° C. might be too low to prevent an irreversible precipitation of metasilicate (A). In case the pH value is higher than 12.8 at 20° C., the pickling at 80° C. is likely to be too strong. In case the pH value is held in the preferred and most preferred ranges, there is a good balance between the cleaning effect, the deposition of the Si-containing layer and pickling which might occur to some extent.

Furthermore, the cleaning and treating composition according to the invention possesses a molar ratio of Si atoms to P atoms being from 0.75:1.0 to 1.0:0.75, preferably being from 0.8:1.0 to 1.0:0.8, more preferred from 0.85:1.0 to 1.0:0.85, such as 0.9:1.0 to 1.0:0.9, based on the sum of the Si-containing metasilicates (A) and the sum of the P-containing orthophosphates (B), diphosphates (C) and triphosphates (C).

### Metasilicates (A)

Mandatory ingredient of the borate-free, aqueous cleaning and treating composition according to the present invention is the at least one metasilicate (A). Most preferred are alkali metal metasilicates, such as sodium metasilicate, potassium metasilicate or lithium metasilicate. Amongst the before-mentioned metasilicates sodium metasilicate and potassium metasilicate are preferred, sodium metasilicate being the most preferred metasilicate. As far as available metasilicates containing water of crystallization such as sodium metasilicate-5-hydrate may be used to prepare the compositions according to the present invention.

Preferably the at least one metasilicate (A) comprised in the compositions according to the present invention is the main Si-containing compound, based on the total weight of Si-containing compounds. The term “main Si-containing compound” means that at least 50 wt.-%, more preferred at least 75 wt.-% and most preferred at least 95 wt.-% of the total weight of Si-containing compounds in the composition according to the present invention are the at least one metasilicate (A). If other Si-containing compounds than the metasilicates (A) are present in the compositions according to the invention, such Si-containing compounds are preferably other water-soluble silicates being fully dissolved in the composition at 20° C.

Most preferred the only Si-containing compounds in the cleaning and treating compositions according to the present invention are metasilicates (A). Since typically technical grades of the metasilicates can be used, metasilicates (A) will still be considered the only Si-containing compounds, if they contain some Si-containing impurities, which are present due to the manufacturing process of the metasilicates (A).

### Orthophosphates (B)

A further mandatory ingredient of the borate-free, aqueous cleaning and treating composition according to the present invention is the at least one orthophosphate (B).

The orthophosphate (B) can also be formed in situ e.g., if using phosphoric acid or an aqueous solution of phosphoric acid to adjust the pH value to the range required.

However, preferably the alkali metal salts of phosphoric acid are employed, such as the mono-alkali metal orthophosphates, di-alkali metal orthophosphates and tri-alkali metal othophosphates. Preferred are sodium orthophosphates, potassium othophosphates and lithium orthophosphates, most preferred are sodium orthophosphates and potassium orthophosphates, amongst which sodium orthophosphates are most preferred.

### Phosphates (C)

The mandatory phosphates (C) are selected from the group consisting of triphosphates and diphosphates.

Preferably alkali metal diphosphates and/or alkali metal triphosphates are employed, such as sodium triphosphate, potassium triphosphate, sodium diphosphate and potassium diphosphate. However, less preferred the corresponding lithium phosphates may be used.

Most preferred, the compositions of the present invention contain diphosphates as well as triphosphates in combination.

Examples of suitable phosphates (C) are penta-sodium triphosphate, penta-potassium triphosphate, tetra-sodium diphosphate and tetra-potassium diphosphate.

### Surfactants (D)

Furthermore, at least one surfactant (D) is contained in the cleaning and treating compositions according to the present invention. Suitable surfactants are selected from the group consisting of anionic surfactants and non-ionic surfactants.

### Anionic Surfactants (D)

Such surfactants are suitably selected from alkali metal salts of linear alkyl benzene sulfonic acid, secondary alkyl sulfonates, fatty alcohol sulfates and alkylether sulfates. Anionic surfactants are typically and preferably solid.

### Non-Ionic Surfactants (D)

Such surfactants are suitably selected from polyalkoxylated alcohols, such as poly (ethoxylated/propoxylated) alcohols, preferably polyethoxylated alcohols, the afore-mentioned alcohols preferably containing 6 to 20 carbon atoms and being linear or branched and preferably primary or secondary alcohols; and ethoxylated fatty amines. Non-ionic surfactants are typically liquid. This does not affect the overall solid state of the solid mixtures of the invention. Preferably, liquid surfactants, particularly non-ionic liquid surfactant are applied onto the surface of the solid ingredients, e.g., by spray application.

### Carbonates (E)

It was also found by the inventors of the present invention that water-soluble carbonates can advantageously be contained in the cleaning and treating compositions of the present invention.

Suitable carbonates are for example the carbonates and hydrogen carbonates of alkali metals, such as sodium carbonate, sodium hydrogen carbonate, potassium carbonate and potassium hydrogen carbonate.

### pH Adjusting Agents

To adjust the pH value of the cleaning and treating compositions of the present invention to the required and preferred ranges as described above, inorganic acids and bases might suitably by used.

Most preferred acid is phosphoric acid and most preferred bases are sodium hydroxide and potassium hydroxide. Most preferred the acids and bases are employed in water-diluted form. In case of the use of phosphoric acid, orthophosphate is generated in situ at the suitable pH range. Therefore, phosphoric acid as a pH adjusting agent adds phosphate to the composition according to the invention, which is to be considered, when calculating molar ratios based on P atoms, because orthophosphate introduced by addition of phosphoric acid (i.e., orthophosphoric acid) is indistinguishable from orthophosphates introduced by the addition of salts of orthophosphoric acid and thus it is treated like the addition of such salt.

For adjustment of the pH during the cleaning and treating process, preferably a solid supplementary mixture including metasilicates and phosphates as well as hydroxides such as sodium hydroxide is added.

### General Aspects of the Cleaning and Treating Compositions

Preferably the total amount of solids contained in the cleaning and treating composition of the present invention ranges from 10 to 60 g/L, more preferred from 15 to 50 g/L and most preferred from 20 to 45 g/L, such as 25-40 g/L.

The total amount of solids is the calculated amount of ingredients added as salts or other ingredients such as surfactants (D), even if the surfactants are in liquid form to produce the compositions according to the invention and non-evaporable ingredients such as the phosphate content of phosphoric acid used to adjust the pH value or the alkali metal ion content of the respective hydroxides to adjust the pH value.

Generally, it is preferred that the molar concentration of Si-atoms from metasilicates (A) contained in the composition according to the invention ranges from 50 to 200 mmol/L, more preferred 70 to 190 mmol/L and most preferred 80 to 180 mmol/L, such as 90 to 170 mmol/L. It is to be understood that the chemical formula of a metasilicate (A) contains 1 Si atom, thus the molar amount of Si-atoms from metasilicates (A) equals the molar amount of metasilicates (A).

Generally, it is preferred that the molar concentration of P-atoms from orthophosphates (B) contained in the composition according to the invention and originating from either solid salts or orthophosphoric acid ranges from 25 to 75 mmol/L, more preferred 30 to 70 mmol/L and most preferred 35 to 65 mmol/L, such as 40 to 60 mmol/L. It is to be understood that the chemical formula of an orthophosphate (B) contains 1 P atom, thus the molar amount of P-atoms from orthophosphates (B) equals the molar amount of orthophosphates (B)

Generally, it is preferred that the molar concentration of P-atoms from phosphates (C) contained in the composition according to the invention ranges from 30 to 130 mmol/L, more preferred 40 to 125 mmol/L and most preferred 45 to 120 mmol/L, such as 50 to 115 mmol/L. It is to be understood that the chemical formula of a diphosphates (C) contains 2 P atoms, thus the molar amount of P-atoms from diphosphates (C) is twice the molar amount of diphosphates (C). It is to be understood that the chemical formula of a triphosphates (C) contains 3 P atoms, thus the molar amount of P-atoms from triphosphates (C) is three times the molar amount of triphosphates (C).

If both, diphosphates (C) and triphosphates (C), are used the molar amount of P-atoms from triphosphates (C) preferably exceeds the molar amount of P-atoms from diphosphates (C), preferably by at least 20 mol-%, even more preferred by at least 25 mol-% and most preferred by at least 30 mol-%.

Preferably, the molar amount of P-atoms from orthophosphates (B) to the molar amount of P-atoms from phosphates (C) is from 1:1.2 to 1:3.5 more preferred from 1:1.3 to 1:3.0, even more preferred from 1:1.4 to 1:2.8.

The total amount of surfactants (D) typically ranges from 0.5 to 10 g/L of the compositions, more preferred from 1 to 8 g/L, even more preferred from 2 to 6 g/L, such as 3 to 5 g/L of the composition of the present invention.

If carbonates (E) are present in the composition of the present invention their molar concentration is preferably in the range from 15 to 100 mmol/L of the composition according to the invention, more preferred 20 to 90 mmol/L, even more preferred 25 to 80 mmol/L and most preferred from 30 to 70 mmol/L.

### Solid Mixtures (M)

The solid mixtures (M) of the present invention typically contain the above described metasilicates (A), preferably orthophosphates (B), phosphates (C), surfactants (D) and preferably carbonates (E) in form of the already above describes alkali metal salts.

Exceptional ingredients are the orthophosphates (B), which are not necessarily contained in the solid mixtures (M), since it is possible to introduce orthophosphates into the cleaning and treating compositions of the present invention by adding phosphoric acid, i.e. orthophosphoric acid to a solution of the solid mixture (M) in water to adjust the pH value to the above described range, thus introducing part or all of the orthophosphate (B) using the phosphoric acid.

Ingredients (A), (B), (C) and if used (E) should be solid at 20° C. and preferably have a water-solubility of at least 50 g/L in water at 20° C. The compositions according to the present invention formed by dissolving the solid mixtures (M) of the present invention and, if necessary, adjusting the pH value should typically not contain undissolved matter from the solid mixture (M).

Surfactants (D) being contained in the solid mixture (M) according to the present invention may be liquid or solid, typically they are liquid. Furthermore, they are readily dissolvable in water when forming the compositions of the present invention by dissolving the solid mixtures (M) of the present invention. The term “dissolvable” in this context includes the formation of micelles which are not considered to be solid particles, but typical structures formed by surfactant molecules in water due to their amphiphilic character.

The solid mixture may further comprise solid carbonates (E), preferably alkali metal carbonates, including alkali metal hydrogen carbonates.

### Method of Preparing the Cleaning and Treating Compositions

The method of preparing the borate-free, aqueous cleaning and treating composition according to the invention, comprises as a first step (I) of dissolving the solid mixture (M) according to the invention in water or an aqueous medium and, if necessary, a second step (II) of adjusting the pH value to the desired and above disclosed range by adding an acid or a base, preferably an inorganic acid or inorganic base, the acid or base preferably being added in form of their dilutions in water and most preferably being selected from phosphoric acid and alkaline metal hydroxides.

### Method of Cleaning and Treating a Metallic Substrate

The invention further relates to a method of cleaning and treating a metallic substrate, comprising the steps of
(a) contacting a metallic substrate with a borate-free, aqueous cleaning and treating composition of the present invention or prepared according to the method as defined above to obtain a cleaned metallic substrate; and
(b) contacting the thus cleaned metallic substrate with an aqueous rinsing composition to remove any excessive cleaning and treating composition.

Optionally, step (a) may be preceded by any suitable cleaning step. A large variety of cleaning formulations for the different types of substrates is commercially available.

Preferably step (a) of “contacting” the metallic substrate with the composition according to the present invention (step (a)) is carried out by dipping the substrate into a bath containing the composition according to the present invention. However, other types of contacting are also possible, e.g., spraying the composition according to the present invention onto the surface of the metallic substrate.

The term “dipping a substrate into a bath” includes the possibility that one or more separate bathes are subsequently used in step (a). This is not limited to, but particularly preferred in case the substrate contains some impurities at its surface, such as oils or grease, before carrying out contacting step (a). Such impurities are particularly removed in the first bath or bathes, thus keeping the subsequent bathes cleaner.

The contacting step (a) is preferably carried out for 1 to 45 min, more preferred for 5 to 40 min, even more preferred for 10 to 30 min and most preferred for 15 to 25 min. The shorter contacting times typically require substrates, which have no or only a small amount of impurities at their surfaces. For short contacting times it is preferred to carry out the afore-mentioned optional cleaning step before carrying out step (a).

Preferably the temperature of the composition according to the present invention in the contacting step (a) is in the range from 40 to 90° C., more preferred 50 to 85° C. and most preferred 60 to 80° C. Generally, it can be concluded that the higher the contacting temperature, the shorter the contacting time can be.

Preferably the contacting time in step (a) is in the range from 10 to 30 min and the contacting temperature is in the range from 50 to 85° C., more preferred the contacting time is in the range from 15 to 25 min and the contacting temperature is in the range from 60 to 80° C.

As already described above, the amount of solids contained in the cleaning and treating composition of the present invention ranges from 10 to 60 g/L, more preferred from 15 to 50 g/L and most preferred from 20 to 45 g/L, such as 25 to 40 g/L.

After carrying out the contacting step (a) the excessive cleaning and treating composition is removed from the surface of the substrate by contacting the cleaned and treated substrate with a rinsing composition, preferably water, in a second step (b). Typically, the rinsing step (b) is carried out by dipping the cleaned and treated substrate in water for one or more times, preferably in one water bath after the other, preferably having increased water purity. While the first water bath might be contaminated with the excessive cleaning composition according to the invention, the second and any following bath will contain less and less of the ingredients of the composition according to the present invention, particularly if the process is carried out as a continuous process making use of the rinsing bathes more than one time. However, this step (b) can also be carried out by spray applying the rinsing compositions, the rinsing compositions preferably being water.

Step (b) is preferably followed by a drying step (c) to remove the excessive water present on the surface of the cleaned, treated and rinsed metallic substrate. Drying conditions can for example range from drying at room temperature up to a temperature of 100° C. or more. The drying time depends on the drying temperature and may preferably range from 1 min to 5 hours or 10 min to 2 hours and the like. Typical drying conditions are 15 min drying at 100° C. Drying can also being increased e.g., by blowing an air stream over the surface of the wet substrate.

After the drying step (c) the cleaned and treated metallic substrates are ready to be bonded by adhesives or coated with coating materials without the need of a further cleaning and/or treating step.

### Metallic Substrates

Preferably the metallic substrates treated in the method of cleaning and treating a metallic substrate are selected from the group consisting of aluminum or an aluminum containing alloy, steel, such as cold rolled steel and galvanized steel, zinc-magnesium coated steel and magnesium alloys.

### Use According to the Present Invention

The invention further concerns the use of a composition according to the invention or obtained according to the respective method of the invention to clean metallic substrates and treat metallic substrates by forming a Si-containing layer on the surface of the metallic substrates.

In the following the invention is further described by way of working examples and comparative examples.

### EXAMPLES

### Solid Mixtures (M)

In Table 1 solid Inventive Mixtures (IM) are shown, which were used to prepare the compositions according to the present invention.

TABLE 1

| | | Mixture Examples IM according to the | | | | |
|---|---|---|---|---|---|---|
| | | Invention [ingredients in g] | | | | |
| Type of Ingredient | Ingredient | IM-1 | IM-2 | IM-3 | IM-4 | IM-5 |
| Metasilicate (A) | Na₂SiO₃ | 20 | 20 | 20 | 20 | — |
| | Na₂SiO₃•5H₂O | — | — | — | — | 19.2 |
| Orthophosphate (B) | NaH₂PO₄ | — | — | 6 | 7 | 4.8 |
| Diphosphate (C) | K₄P₂O₇ | — | 19 | 19 | 8 | 4 |
| Triphosphate (C) | Na₅P₃O₁₀ | 14 | — | — | 8 | 4 |
| Anionic Surfactant (D) | alkylbenzene | 2 | 2 | 2 | 2 | 2 |
| | sulfonic acid | | | | | |
| | salt | | | | | |
| Non-ionic Surfactant (D) | ethoxylated | 2 | 2 | 2 | 2 | 2 |
| | fatty alcohol | | | | | |
| Carbonate (E) | K₂CO₃ | — | — | — | 8 | — |
| | Na₂CO₃ | — | — | — | — | 4 |

| | | | | | |
|---|---|---|---|---|---|
| Sum of Ingredients [g] | 38 | 43 | 49 | 55 | 40 |

While all inventive mixtures (IM) contain the metasilicate (A), a diphosphate (C) and/or a triphosphate (C), and an anionic surfactant as well as a non-ionic surfactant (D), inventive mixtures IM-3, IM-4 and IM-5 also contain an orthophosphate, while inventive mixture IM-1 and IM-2 do not contain an orthophosphate. When dissolving mixtures IM-1 and IM-2 to produce borate-free, aqueous cleaning and treating compositions according to the invention, the pH value is being adjusted with phosphoric acid (IM-1:5.30 g of phosphoric acid (75%); IM-2:5.60 g of phosphoric acid (75%)), thus introducing the orthophosphate to the respective cleaning and treating composition.

In Table 2 the ingredients of Comparative Mixtures CM-1 are shown.

TABLE 2

| | | Comparative Mixture Examples CM | | | | | | |
|---|---|---|---|---|---|---|---|---|
| | | [ingredients in g] | | | | | | |
| Type of | | CM- | CM- | CM- | CM- | CM- | CM- | CM- |
| Ingredient | Ingredient | 1 | 2 | 3 | 4 | 5 | 6 | 7 |
| Metasilicate (A) | Na₂SiO₃ | 20 | 36 | 36 | 20 | — | — | — |
| Disilicate | Na₂Si₂O₅ | — | — | — | — | 17 | 17 | 17 |
| Borate | K₂B₄O₇•4H₂O | 13.4 | — | — | — | — | — | — |
| | Na₂B₄O₇•5H₂O | 2.6 | — | — | — | — | — | — |
| Orthophosphate | NaH₂PO₄ | — | — | — | 14 | 14 | — | — |
| (B) | | | | | | | | |
| Diphosphate (C) | K₄P₂O₇ | — | — | — | — | — | — | 19 |
| Triphosphate | Na₅P₃O₁₀ | — | — | — | — | — | 14 | — |
| (C) | | | | | | | | |
| Anionic | alkylbenzene | 2 | 2 | 2 | 2 | 2 | 2 | 2 |
| Surfactant (D) | sulfonic acid | | | | | | | |
| | salt | | | | | | | |
| Non-ionic | ethoxylated | 2 | 2 | 2 | 2 | 2 | 2 | 2 |
| Surfactant (D) | fatty alcohol | | | | | | | |
| Carbonate (E) | K₂CO₃ | — | — | — | — | — | — | — |

| | | | | | | | |
|---|---|---|---|---|---|---|---|
| Sum of Ingredients [g] | 40 | 40 | 40 | 38 | 35 | 35 | 40 |

Comparative Mixture CM-1 contains borate which should be avoided in the present invention. Comparative Mixtures CM-1, CM-2 and CM-3 are completely P-free. CM-4 and CM-5 lack any phosphates (C). CM-5, CM-6 and CM-7 contain no metasilicate, but disilicate instead.

### Borate-Free, Aqueous Cleaning and Treating Composition

Following Table 3 shows the amounts of Inventive Mixtures (IM) and Comparative Mixtures (CM) used to prepare 1 Liter of the Compositions (IC) according to the invention and 1 Liter of the Comparative Compositions (CC), respectively, as well as the amounts of pH adjusting agent 50 wt.-% potassium hydroxide solution in water or 75 wt.-% phosphoric acid solution in water and the final pH values at 20° C. (room temperature).

TABLE 3

| | | | KOH (50 | Phosphoric acid | |
|---|---|---|---|---|---|
| Compo- | | Mixture | wt.-% in | (75 wt.-% in | pH |
| sition | Mixture | [g] | water) [g] | water) [g] | value |
| IC-1 | IM-1 | 38 | — | 5.3 | 12.2 |
| IC-2 | IM-2 | 43 | — | 5.6 | 12.2 |
| IC-3 | IM-3 | 49 | — | — | 12.2 |
| IC-4 | IM-4 | 55 | — | — | 12.2 |
| IC-5 | IM-5 | 40 | — | — | 12.2 |
| CC-1 | CM-1 | 40 | — | — | 12.2 |
| CC-2 | CM-2 | 40 | — | — | 12.7 |
| CC-3 | CM-3 | 40 | | 3.67 | 12.2 |
| CC-4 | CM-4 | 38 | 5.00 | — | 11.9 |
| CC-5 | CM-5 | 35 | 17.00 | — | 11.9 |
| CC-6 | CM-6 | 35 | 6.50 | — | 12.2 |
| CC-7 | CM-7 | 40 | 5.50 | — | 12.2 |

Table 4 shows the molar amounts of Si atoms and P atoms in mmol/L and their origin from solid ingredients (A), (B), (C) and, where applies from phosphoric acid (“from acid”), respectively.

TABLE 4

| | | | Ortho- | | | | |
|---|---|---|---|---|---|---|---|
| | Silicate | | phosphate | | | | |
| | Meta- | | (B) | | Phosphate (C) | | Molar |
| | silicate | Di- | From | From | Di- | Tri- | ratio |
| Comp. | (A) | silicate | Salt | Acid | phosphate | phosphate | Si/P |
| IC-1 | 164 | — | — | 41 | — | 114 | 1.1 |
| IC-2 | 164 | — | — | 43 | 115 | — | 1.0 |
| IC-3 | 164 | — | 50 | — | 115 | — | 1.0 |
| IC-4 | 164 | — | 58 | — | 48 | 65 | 1.0 |
| IC-5 | 90 | — | 40 | — | 24 | 33 | 0.9 |
| CC-1 | 164 | — | — | — | — | — | ./. |
| CC-2 | 295 | — | — | — | — | — | ./. |
| CC-3 | 295 | — | — | 28 | — | — | 10.5 |
| CC-4 | 164 | — | 117 | — | — | — | 1.4 |
| CC-5 | — | 187 | 117 | — | — | — | 1.6 |
| CC-6 | — | 187 | — | — | — | 114 | 1.6 |
| CC-7 | — | 187 | — | — | 115 | — | 1.6 |

### Method of Cleaning and Treating a Metallic Substrate

As metallic substrates panels AW-5005 (AlMg1) (an aluminum/magnesium alloy; see also: DIN EN 573-3:2009-08) and AA6014 (an aluminum/magnesium/silicon alloy) were used as commercially available from Chemetall GmbH, Frankfurt, Germany, in oiled form and had a size of 10.5×19 cm.

The genuine silicon content at the surface of the panels, expressed as Si and determined by XRF spectroscopy, was 1 mg/m² for the aluminum-based alloy AW5005 (AlMg1) and 10 mg/m² for the aluminum-based alloy AA6014.

The inventive compositions IC-1 to IC-5 and the comparative compositions CC-1 to CC-7 were heated in separate bathes to 80° C. The panels were immersed in the separate compositions for 24 min by dipping the panels into the bathes. Afterwards the panels were removed and dip-rinsed in a water bath for 6 min and dip-rinsed again in another water bath for 3 min to remove any excessive cleaning and treating composition. Subsequently the panels were dried for 15 min at 100° C.

After drying, the panels were cut with gate shears into 3.5×3.5 cm samples and analyzed for the Si-content on the surface by RFA analysis.

As RFA instrument a Panalytical Axios max device was used (Rh tube 3KW, channel Si Kₐₗₚₕₐ, measurement under vacuum, orifice 27 mm, collimator 300 μm, flow meter, excitation 24 KV-110 mA, Crystal PE002; 2 Teta angle maximum 109,1°; background 1 107,1° and background 2 110,4°, measuring times maximum 30 s background 10 s each).

The values of the Si content given in Table 5 are baseline corrected values, meaning that in case of the use of AW-5005 (AlMg1) an amount of 1 mg/m² and in case of the use of AA6014 an amount of 10 mg/m², was subtracted from the value determined in the above RFA analysis. Shown is the average value of two measurements, rounded up to integer values.

Furthermore, the optical appearance was evaluated. As reference the borate-containing Comparative Composition CC-1 was chosen and rated “Okay”.

In the last column of Table 5, a remark regarding the overall evaluation is shown, including the stability of the compositions and workability of the mixture used to prepare the respective compositions.

TABLE 5

| | Si-content on the | | | | |
|---|---|---|---|---|---|
| | surface of the substrate | | | | |
| | [mg/m²] | | Optical appearance | | |
| | | AW-5005 | | AW5005 | |
| Comp. | AA6014 | (AlMg1) | AA6014 | (AlMg1) | Remarks |
| IC-1 | 2 | 3 | as CC-1 | as CC-1 | fulfills all requirements |
| IC-2 | 5 | 7 | as CC-1 | as CC-1 | fulfills all requirements |
| IC-3 | 3 | 4 | as CC-1 | as CC-1 | fulfills all requirements |
| IC-4 | 5 | 6 | as CC-1 | as CC-1 | fulfills all requirements |
| IC-5 | 6 | 7 | as CC-1 | as CC-1 | fulfills all requirements |
| CC-1 | 5 | 8 | Okay | Okay | borate-containing |
| CC-2 | 14 | 28 | pickled | pickled | Si content much to high; |
| | | | | | bad optical appearance |
| CC-3 | 5 | 9 | slightly | slightly | bad optical appearance; |
| | | | pickled | pickled | loss of gloss |
| CC-4 | 3 | 6 | as CC-1 | as CC-1 | pH value is hard to |
| | | | | | control |
| CC-5 | 4 | 8 | as CC-1 | as CC-1 | pH value is hard to |
| | | | | | control |
| CC-6 | 5 | 8 | as CC-1 | as CC-1 | solid mixture lumped |
| CC-7 | 3 | 7 | as CC-1 | as CC-1 | solid mixture lumped |

Further to the above experiments, Inventive Composition IC-5 was further investigated regarding the relevance of treatment time, treatment temperature and concentration of ingredients in the composition on the Si-content on the surface of the substrate. For this study, the substrate panels were pre-cleaned, i.e., ligroin-degreased, before carrying out the method according to the invention.

It was found that a treatment time as low as about 6 min (temperature 80° C.; concentration 40 g IM-5/L) still leads to satisfactory Si-contents on the surface of the substrate AA6014. The Si-content found after a 6-min treatment compared to a 24-min treatment was still about 75% compared to 85%.

Even after reducing the concentration of the ingredients to 10 g IM-5/L (4-fold reduction of ingredients), reducing the treatment temperature to 50° C. and reducing the treatment time to 1 min, the Si-content found on the surfaces of both substrates was still in the acceptable baseline corrected range, being 2 mg/m².

From the studies, it was deducted that
a longer treatment time at given temperature and concentration leads to a higher Si-content on the surface of the substrate;
a higher treatment temperature at a given treatment time and concentration leads to a higher Si-content on the surface of the substrate; and
a higher concentration of the ingredients at a given treatment time and treatment temperature may lead to a higher Si-content on the surface of the substrate.

Thus, all compositions prepared by using IM-5 in a concentration range from 10 g/L to 40 g/L, used at a temperature of 50° C. to 85° C. for a time up to 24 min showed satisfactory results regarding the Si-content on the treated metallic surfaces of both substrates. The higher the treatment time and temperature and concentration, the closer was the Si-content to the upper value of the desired range being from 2 to 7 mg/m² and the lower the treatment time and temperature and concentration, the closer was the Si-content to the lower value of the before-mentioned range.

1. A borate-free, aqueous cleaning and treating composition comprising
at least one metasilicate (A);
at least one orthophosphate (B);
at least one phosphate (C) selected from the group consisting of diphosphates and triphosphates; and
at least one surfactant (D) selected from the group consisting of anionic surfactants and non-ionic surfactants; and wherein
the aqueous cleaning and treating composition
i. has a pH value at 20°° C. in a range from 11.0 to 12.8; and
ii. has a molar ratio of Si atoms to P atoms being from 0.75:1 to 1:0.75, based on the sum of the Si-containing metasilicates (A) and the sum of the P-containing orthophosphates (B), diphosphates (C) and triphosphates (C).

2. The borate-free, aqueous cleaning and treating composition according to claim 1, wherein it further contains at least one carbonate in the aqueous cleaning and treating composition.

3. The borate-free, aqueous cleaning and treating composition according claim 1, wherein it contains at least one diphosphate (C) and at least one triphosphate (C).

4. The borate-free, aqueous cleaning and treating composition according to claim 1, wherein the molar ratio of the sum of the P-atoms in the orthophosphates (B) to the sum of the P-atoms in phosphates (C) is from 1:1.2 to 1:3.5.

5. The borate-free, aqueous cleaning and treating composition according to claim 1, wherein the metasilicates (A), orthophosphates (B) and phosphates (C) are the salts of alkaline metals.

6. The borate-free, aqueous cleaning and treating composition according to claim 1, wherein
i. the molar concentration of the sum of Si-atoms from metasilicates (A) is in a range from 50 to 200 mmol/L;
ii. the molar concentration of the sum of P-atoms from orthophosphates (B) is in a range from 25 to 75 mmol/L;
iii. the molar concentration of the P-atoms from phosphates (C) is in a range from 30 to 130 mmol/L; and
iv. the concentration of surfactants (D) is in a range from 0.5 to 10 g/L and
the concentrations being based on 1 Liter of the borate-free, aqueous cleaning and treating composition.

7. A method of preparing the borate-free, aqueous cleaning and treating composition according to claim 1, wherein in a
first step (I)
a solid mixture (M), comprising
at least one metasilicate (A);
at least one orthophosphate (B), in case no phosphoric acid is used in the second step (II);
at least on diphosphate (C) and/or triphosphate (C); and
at least one surfactant (D) selected from the group consisting of anionic surfactants and non-ionic surfactants;
is dissolved in water to obtain an aqueous solution; and, if necessary-optionally, in a second step (II)
the pH value of the aqueous solution obtained in the first step (II) is adjusted to a range from 11.0 to 12.8.

8. The method of preparing the borate-free, aqueous cleaning and treating composition according to claim 7, wherein the solid mixture (M) further contains at least one carbonate (E).

9. A solid mixture (M) for use in the method of preparing the borate-free, aqueous cleaning and treating composition, according to claim 7, wherein the solid mixture (M) comprises
at least one metasilicate (A);
optionally at least one orthophosphate (B);
at least one phosphate (C) selected from the group consisting of diphosphates and triphosphates; and
at least one surfactant (D) selected from the group consisting of anionic surfactants and non-ionic surfactants,
wherein each species (A), (B) and (C) is solid.

10. The solid mixture (M) according to claim 9, wherein the solid mixture (M) further contains at least one solid carbonate (E).

11. A method of cleaning and treating a metallic substrate, comprising
a. contacting a metallic substrate with the borate-free, aqueous cleaning and treating composition according to claim 1 to obtain a cleaned metallic substrate; and
b. contacting the thus cleaned metallic substrate with an aqueous rinsing composition to remove any excessive cleaning and treating composition.

12. The method of cleaning and treating a metallic substrate according to claim 11, wherein step (a) the metallic substrate is contacted with the borate-free, aqueous cleaning and treating composition by dipping the metallic substrate in a bath containing the borate-free, aqueous cleaning and treating composition for 1 to 45 min, the bath having a temperature in a range from 40 to 90° C.

13. The method of cleaning and treating a metallic substrate according to claim 11, wherein the metallic substrate is selected from the group consisting of aluminum or an aluminum containing alloy, steel, and magnesium alloys.

14. A method of using the composition according to claim 1, the method comprising using the composition to clean metallic substrates and treat metallic substrates by forming a Si-containing layer on the surface of the metallic substrates.

15. The method of cleaning and treating a metallic substrate according to claim 11, wherein the steel is cold rolled steel, galvanized steel, or zinc-magnesium coated steel.
